(19) United States
(12) Patent Application Publication
(10) Pub. No.: US 2025/0277324 A1
(43) Pub. Date: Sep. 4, 2025

(54) COMPOSITE MATERIAL, METHOD FOR PRODUCING THE COMPOSITE MATERIAL, AND TERMINAL

(71) Applicant: DOWA METALTECH CO., LTD., Tokyo (JP)

(72) Inventors: Yukiya KATO, Tokyo (JP); Takao TOMIYA, Tokyo (JP); Hirotaka KOTANI, Tokyo (JP); Hirotaka TAKAHASHI, Tokyo (JP); Airi HIRAYAMA, Tokyo (JP)

(73) Assignee: DOWA METALTECH CO., LTD., Tokyo (JP)

(21) Appl. No.: 18/861,019

(22) PCT Filed: Apr. 5, 2023
(86) PCT No.: PCT/JP2023/014089

§ 371 Date: Oct. 28, 2024

(30) Foreign Application Priority Data
May 11, 2022 (JP) 2022-078052

(51) Int. Cl. C25D 15/00; H01B 1/02

(52) U.S. Cl. CPC C25D 15/00; H01B 1/02

(57) ABSTRACT

There is provided a composite material in which a composite coating composed of a silver layer containing carbon particles is provided on a base material, wherein when the composite coating is observed with a laser microscope, a proportion of predetermined protrusions in an observation field is 12% or more by area.

### TECHNICAL FIELD

The present invention relates to a composite material in which a predetermined composite coating is provided on a base material, a method for producing the same, etc., and particularly, relates to a composite material used as a material for sliding electrical contact parts such as switches and connectors, and a method for producing the same.

### DESCRIPTION OF RELATED ART

Conventionally, a silver (Ag) plated material with silver plating applied to a conductive material, is used as a material for sliding electrical contact parts such as switches and connectors, to prevent oxidation of the conductive material such as copper (Cu) and a copper alloy due to heating during a sliding process.

However, silver plating is soft and easily worn, and generally has a high friction coefficient, thus involving a problem that it easily peels off due to sliding. In order to solve this problem, there is a method of improving wear resistance by applying a coating of a composite material onto a conductive material by electroplating, using the composite material in which graphite particles that are one of the carbon particles such as graphite and carbon black that have excellent abrasion resistance and lubricity are dispersed in a silver matrix (for example, see Patent documents 1 and 2).
[Patent Document 1] U.S. Pat. No. 3,054,628
[Patent Document 2] U.S. Pat. No. 4,806,808

### SUMMARY OF THE INVENTION

### Problem to be Solved by the Invention

For example, in the automotive industry, as autonomous driving advances, in addition to having excellent electrical conductivity, sliding electrical contact parts such as automotive switches and connectors are required to have higher reliability than ever before (little deterioration in electrical conductivity even after exposure to high-temperature environments). The same applies to sliding electrical contact parts used in other electronic devices.

Under such a circumstance of the increasingly higher requirement, the composite materials of Patent documents 1 and 2 are insufficiently reliable.

The composite materials disclosed in Patent documents 1 and 2 are configured as follows: in a composite coating (AgC coating) containing carbon particles, copper diffuses from a copper base material through grain boundaries serving as diffusion paths between crystals that constitute a silver matrix. Especially when the composite coating is thin, copper easily diffuses by heating into the composite coating, reaches a composite coating surface and is oxidized, increasing resistance. That is, the reliability is insufficient. The reliability can be improved by making the composite coating thicker and increasing a distance to the coating surface, but in this case, a producing cost of the composite material is increased.

The present invention has been made under the above circumstances, and an object of the present invention is to provide a composite material in which a composite coating containing carbon particles in a silver layer is formed on a base material, and which has excellent reliability even though the composite coating is thin, and a method for producing the composite material and a terminal for electrical contacts using the composite material.

### Means for Solving the Problem

Extensive research into solving the above problem is carried out and the result is as follows: when carbon particles are subjected to a predetermined surface treatment using a specific benzoic acid compound and then electroplating is performed using a silver plating solution containing the carbon particles, it is found that the composite coating has a predetermined amount of protrusions. It is also found that such a composite coating has excellent reliability even though it is thin. As a result of the above, the present inventors have completed the present invention.

That is, the present invention is as follows.

[1] A composite material in which a composite coating composed of a silver layer containing carbon particles is provided on a base material,
wherein when observing the composite coating with a laser microscope to obtain a pixel height, which is a height difference between each pixel constituting an observation field and a lowest pixel in the observation field, and when a pixel height of a pixel whose cumulative number ratio is 10% in an arrangement of pixel heights in an ascending order is defined as a reference height H₀, and a pixel in the observation field whose pixel height is 1 μm or more higher than the reference height H₀ is defined as a protrusion, a proportion of the protrusions in the observation field is 12% or more by area.
   [2] The composite material according to [1], wherein the base material is composed of Cu or a Cu alloy.
   [3] The composite material according to [1] or [2], wherein a crystallite size of silver in the composite coating is 40 nm or less.
   [4] The composite material according to any one of [1] to [3], wherein a proportion of the protrusions is 15 to 75% by area.
   [5] The composite material according to any one of [1] to [4], wherein a proportion of the carbon particles in a composite coating surface is 10 to 80% by area.
   [6] The composite material according to any one of [1] to [5], wherein a thickness of the composite coating is 1.5 to 25 μm.
   [7] The composite material according to any one of [1] to [6], wherein the composite coating surface has a Vickers hardness of 100 or more.
   [8] The composite material according to any one of [1] to [7], wherein the composite coating has an arithmetic mean roughness Ra of 0.6 μm or more.
   [9] The composite material according to any one of [1] to [8], wherein an underlayer composed of at least one selected from a group consisting of Cu, Ni, Sn, and Ag is provided between the base material and the composite coating.

A method for producing a composite material, including:
performing electroplating in a silver plating solution containing carbon particles; and
forming a composite coating composed of a silver layer containing carbon particles on a base material,
wherein the carbon particles are surface-treated carbon particles that have been treated in an aqueous solution, with compound A represented by the following general formula (1) for 30 minutes or more,

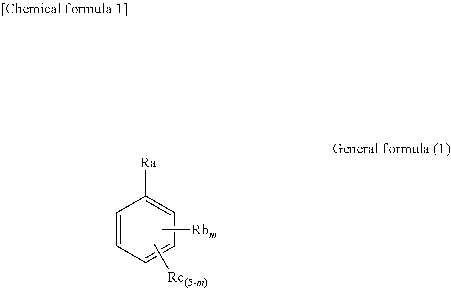

(in formula (1), m is an integer from 1 to 5;
Ra is a carboxyl group;
Rb is an aldehyde group, a carboxyl group, an amino group, a hydroxyl group, or a sulfonic acid group;
Rc is hydrogen or an arbitrary substituent;
when m is 2 or more, multiple Rb's may be the same or different;
when m is 3 or less, multiple Rc's may be the same or different; and
Ra and Rb may each independently be bonded to a benzene ring via a divalent group composed of at least one selected from a group consisting of —O— and —CH₂—.)
   [11] The method for producing a composite material according to [10], wherein the silver plating solution contains the surface-treated carbon particles and a compound B represented by the following general formula (2):

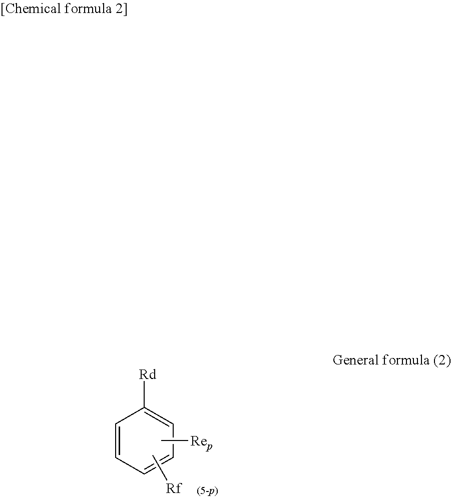

(in formula (2), p is an integer from 1 to 5,
Rd is a carboxyl group,
Re is an aldehyde group, a carboxyl group, an amino group, a hydroxyl group, or a sulfonic acid group,
Rf is hydrogen or an arbitrary substituent,
when p is 2 or more, multiple Re's may be the same or different,
when p is 3 or less, multiple Rf's may be the same or different, and
Rd and Re may each independently be bonded to a benzene ring via a divalent group composed of at least one selected from a group consisting of —O— and —CH₂—.)
   [12] The method for producing a composite material according to or [11], wherein the base material is composed of Cu or a Cu alloy.
   [13] The method for producing a composite material according to any one of to [12], wherein the treatment for the carbon particles with compound A is performed by stirring an aqueous solution containing the carbon particles and compound A for 30 minutes or more.
   [14] The method for producing a composite material according to any one of to [13], wherein a concentration of compound B in the silver plating solution is 2 to 250 g/L.
   [15] The method for producing a composite material according to any one of to [14], wherein the silver plating solution contains silver ions at a concentration of 5 to 150 g/L.
   [16] The method for producing a composite material according to any one of to [15], wherein a concentration of the surface-treated carbon particles in the silver plating solution is 10 to 150 g/L.

A terminal for electrical contacts, the terminal comprising the composite material according to any one of [1] to [9] as a constituent material.

### Advantage of the Invention

According to the present invention, there is provided a composite material in which a composite coating containing carbon particles in a silver layer is provided on a base material, and which has excellent reliability even though the composite coating is thin, a method for producing the same, and a terminal for electrical contacts using the composite material.

### BRIEF DESCRIPTION OF THE DRAWING

FIG. 1 shows a frequency distribution chart of a pixel height of each pixel constituting an image observed with a laser microscope, which is created in order to obtain a protrusion area percentage according to an example. (a) is a frequency distribution chart according to Example 6, and (b) is a frequency distribution chart according to Comparative Example 3.

### DETAILED DESCRIPTION OF THE INVENTION

Hereinafter, an embodiment of the present invention will be described.

### [Method for Producing a Composite Material]

According to an embodiment of the present invention, there is provided a method for producing a composite material, in which a composite coating containing carbon particles in a silver layer is provided on a base material by electroplating in a silver plating solution containing carbon particles that have been subjected to a specific surface treatment. Each configuration of the production method of this composite material will be described hereafter.

### <<Base Material>>

The constituent material of the base material on which the composite coating is provided, is preferably the one that can be plated with silver and has an electrical conductivity required for sliding contact parts such as switches and connectors, and further, from a viewpoint of a cost, Cu (copper) and Cu alloys are preferable as the constituent material of the base material. As the Cu alloy, from the viewpoints of electrical conductivity, strength, etc., an alloy composed of Cu, and at least one selected from the group consisting of Si (silicon), Fe (iron), Mg (magnesium), P (phosphorus), Ni (nickel), Sn (tin), Co (cobalt), Zn (zinc), Be (beryllium), Pb (lead), Te (tellurium), Ag (silver), Zr (zirconium), Cr (chromium), Al (aluminum) and Ti (titanium), and inevitable impurities is preferable. An amount of Cu in the Cu alloy is preferably 85% by mass or more, more preferably 92% by mass or more (the amount of Cu is preferably 99.95% by mass or less).

The base material is preferably used in a terminal application (as a composite material attached with a multi-layer coating) as described below, and the base material itself may have a shape for that application, or the base material may be flat (such as a plate shape) and is then formed into a desired shape as a composite material in some cases.

### <<Formation of an Underlayer>>

In the method for producing a composite material of the present invention, an underlayer may be formed on the base material, and the underlayer may be electroplated as described below. The underlayer is formed for the purpose of preventing the copper of the base material from diffusing through to a plating surface to be oxidized, which deteriorates reliability of the composite material, and for the purpose of improving adhesion of the composite coating. The constituent metal of the underlayer is at least one metal or an alloy selected from the group consisting of Cu, Ni, Sn, or Ag. The underlayer may be a layer composed of Cu, Ni, Sn, or Ag, or a layer composed of a combination of these (a laminate structure), and the underlayer may be formed on an entire surface of the base material or on only a part of it, depending on the application of the composite material to be produced.

There is no particular limitation in the method for forming the underlayer, and the underlayer can be formed by electroplating using a plating solution containing ions of the above-described constituent metals by a known method, and can be formed by sequentially stacking layers composed of the metals that constitute a target alloy layer, followed by reflow (heat treatment). From a viewpoint of a wastewater treatment cost, it is preferable that the plating solution does not substantially contain a cyanide compound.

### <<Ag Strike Plating>>

Before forming the composite coating on the base material, it is preferable to form a very thin intermediate layer by Ag strike plating to improve adhesion between the base material and the composite coating. When the underlayer is formed on the base material, it is preferable to perform Ag strike plating on the underlayer (to improve adhesion between the underlayer and the composite coating). As a method for performing Ag strike plating, any conventionally known method can be used without particular limitation as long as it does not impair the effects of the present invention. It is preferable that the plating solution used in Ag strike plating does not substantially contain a cyanide compound from the point of a wastewater treatment cost.

### <<Electroplating>>

The method for producing a composite material of the present invention is as follows: in a specific silver plating solution, electroplating is performed to the above-described base material after forming an underlayer and/or an intermediate layer by Ag strike plating as necessary, to form a composite coating on the base material that contains carbon particles in a silver layer.

### <Silver Plating Solution>

The silver plating solution contains silver ions and carbon particles that have been subjected to a specific surface treatment, and preferably contains a specific compound B.

### {Silver Ion}

The silver plating solution contains silver ions. The silver concentration in this silver plating solution is preferably 5 to 150 g/L, more preferably 10 to 120 g/L, and most preferably 20 to 100 g/L, from the viewpoints of the rate of formation of the composite coating and of suppressing unevenness in the appearance of the composite coating.

### {Surface-Treated Carbon Particles}

The silver plating solution contains surface-treated carbon particles that have been subjected to a surface treatment described below. From the viewpoint of the wear resistance of the composite material obtained by forming a composite coating on a base material using a silver plating solution, and since the amount of carbon particles that can be introduced into the composite coating is limited, the amount of the surface-treated carbon particles in the silver plating solution is preferably 10 to 150 g/L, more preferably 15 to 120 g/L, and particularly preferably 30 to 100 g/L.

When the composite coating (silver plating film) is formed on a base material by electroplating, similar to conventionally used carbon particles, the surface-treated carbon particles are entrapped in a silver matrix, resulting in increasing the wear resistance of the composite material. The inclusion of carbon particles in the composite coating increases the wear resistance of the composite material. From the viewpoint of exerting such a function, the carbon particles are preferably graphite particles. The carbon particles preferably have a volume-based cumulative 50% particle size (D50) of 0.5 to 15 μm, further preferably 1 to 10 μm as measured by a laser diffraction/scattering particle size distribution measuring device, from the viewpoint of ease of inclusion in the silver matrix. Further, the shape of the carbon particles is not particularly limited and may be substantially spherical, flaky, or amorphous. However, a flaky shape is preferable because it can improve the wear resistance of the composite material by smoothing the composite coating surface.

### (Oxidation Treatment of Carbon Particles)

Further, it is preferable to subject these carbon particles (before being surface-treated) to an oxidation treatment to remove lipophilic organic matter adsorbed on the surface of the carbon particles, thereby increasing the dispersibility of the carbon particles in the silver plating solution. Such lipophilic organic matters include aliphatic hydrocarbons such as alkanes and alkenes, and aromatic hydrocarbons such as alkylbenzenes. As the oxidation treatment for the carbon particles, other than a wet oxidation treatment, a dry oxidation treatment using O₂ gas, etc., can be used. However, from the viewpoint of mass productivity, it is preferable to use the wet oxidation treatment. Carbon particles with a large surface area can be uniformly treated by the wet oxidation treatment. As a method for the wet oxidation treatment, a method of suspending carbon particles in water and then adding an appropriate amount of an oxidizing agent can be used. The oxidizing agent that can be used includes nitric acid, hydrogen peroxide, potassium permanganate, potassium persulfate (potassium peroxodisulfate), sodium perchlorate, etc. It is considered that the lipophilic organic matter adhering to the carbon particles is oxidized by the added oxidizing agent to become easily soluble in water, and is then appropriately removed from the surface of the carbon particles. Filtration and further rinsing of the carbon particles with water after the wet oxidation treatment can further enhance the effect of removing the lipophilic organic matter from the surface of the carbon particles. By the oxidation treatment for the carbon particles, lipophilic organic matters such as aliphatic and aromatic hydrocarbons can be removed from the surface of the carbon particles, and according to the analysis using 300° C. heated gas, the gas generated by heating the carbon particles after the oxidation treatment at 300° C. contains almost no lipophilic aliphatic hydrocarbons such as alkanes and alkenes, or lipophilic aromatic hydrocarbons such as alkylbenzenes. Even when the carbon particles after oxidation treatment contain small amounts of aliphatic or aromatic hydrocarbons, the carbon particles can be uniformly dispersed in the silver plating solution used in the present invention, but it is preferable that the carbon particles do not contain any hydrocarbons having a molecular weight of 160 or more, and that the intensity of the gas evolved from hydrocarbons having a molecular weight of less than 160 in the carbon particles when heated at 300° C. (intensity determined by purge and trap gas chromatography mass spectrometry) is 5,000,000 or less.

### (Surface Treatment of Carbon Particles)

In the present invention, the carbon particles that have been subjected to the above-described oxidation treatment are preferably treated with a specific compound A in an aqueous solution for 30 minutes or more. When electroplating is performed using the silver plating solution containing carbon particles that have been subjected to such a treatment, a composite coating (a plating layer composed of a silver layer containing carbon particles) having a predetermined number of protrusions is formed. The composite material in which the composite coating having such protrusions is formed on a base material has excellent reliability.

The compound A is represented by the following general formula (1).

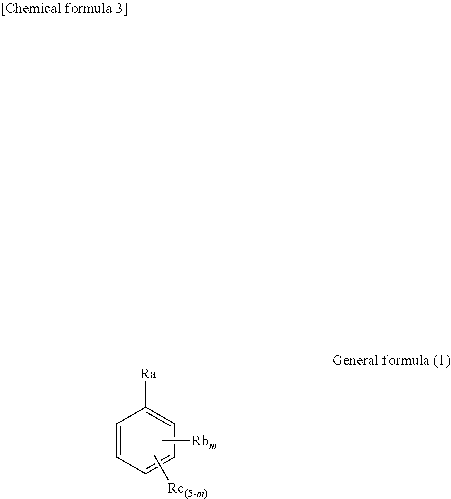

In formula (1), m is an integer of 1 to 5, Ra is a carboxyl group, Rb is an aldehyde group, a carboxyl group, an amino group, a hydroxyl group, or a sulfonic acid group, Rc is hydrogen or an optional substituent, and Ra and Rb may each independently be bonded to a benzene ring via at least one divalent group selected from the group consisting of —O— and —CH₂—. Examples of the divalent group include —CH₂—CH₂—O—, —CH₂—CH₂—CH₂—O—, and (—CH₂—CH₂—O—) n (n is an integer of 2 or more).

In formula (1), when m is 2 or more, multiple Rb's may be the same or different, and when m is 3 or less, multiple Rc's may be the same or different. Regarding Rc, the “optional substituent” includes an alkyl group having 1 to 10 carbon atoms, an alkylaryl group, an acetyl group, a nitro group, a halogen group, and an alkoxyl group having 1 to 10 carbon atoms.

From the viewpoint of forming sufficient protrusions and obtaining a composite material with excellent reliability, Rb's are preferably a carboxyl group, m is preferably 1, and Rc's are preferably hydrogen.

Specifically, the treatment of carbon particles with compound A (hereinafter also simply referred to as a surface treatment) can be performed, for example, as follows.

The aqueous solution containing the carbon particles and compound A is stirred for 30 minutes or more. It is considered that this causes compound A to be adsorbed on the surface of the carbon particles. When electroplating is performed to the base material using a silver plating solution containing such surface-treated carbon particles, similarly to the electroplating with a silver plating solution containing untreated carbon particles, a silver matrix is formed and the surface treated carbon particles are entrapped within the silver matrix to form a composite coating. During the formation of the composite coating, the surface state is considered as follows: the surface-treated carbon particles are present, some of which are exposed but entrapped in the silver matrix, and in these exposed portions of the particles where compound A is adsorbed, silver (Ag) precipitates (usually silver precipitates on silver), and this precipitate grows to form protrusions. That is, it is considered that compound A serves as a starting point for silver precipitation. From the viewpoint of the reliability of the resulting composite material and the production cost, the time for stirring the aqueous solution containing carbon particles and compound A (surface treatment time) is preferably 45 minutes to 300 hours, and more preferably 55 minutes to 250 hours. Compound A is the same compound as compound B described later. When non-surface-treated carbon particles and compound B described in this section are added to the silver plating solution to prepare a plating solution containing carbon particles, etc., it can be considered that the carbon particles have been surface-treated with compound B for several seconds to several minutes. However, the effect of the present invention cannot be obtained with such a short-time treatment (see Comparative example 2 described later).

The aqueous solution used in the surface treatment may be pure water or a mixed solvent of water and an organic solvent. In the case of the mixed solvent, the water content in the solvent is preferably 60% by mass or more, and more preferably 80% by mass or more, from the viewpoint of the reliability of the resulting composite material. In addition, when taking into consideration an environmental impact, pure water is particularly preferable as the aqueous solution.

The amount of carbon particles used per 100 parts by mass of the aqueous solution is preferably 2 to 15 parts by mass, and more preferably 3 to 10 parts by mass, from the viewpoint of the efficiency of the surface treatment.

The amount of compound A used per 100 parts by mass of carbon particles is preferably 0.8 to 10 parts by mass, and more preferably 1.5 to 5 parts by mass, from the viewpoints of the reliability of the resulting composite material and a production cost.

The temperature of the aqueous solution during the surface treatment is preferably from 10 to 50° C., more preferably from 20 to 35° C., from the viewpoint of surface treatment efficiency.

Further, stirring during the surface treatment can be performed with a stirrer or a stirring blade, and a rotation speed is preferably 250 to 600 rpm, more preferably 300 to 500 rpm, from the viewpoint of the efficiency of the surface treatment and the reliability of the resulting composite material.

After the surface treatment with compound A has been performed as described above, the aqueous solution containing the surface-treated carbon particles may be filtered, and the filtered product may be rinsed with water to recover the surface-treated carbon particles.

### {Compound B}

Next, the silver plating solution preferably contains compound B. Compound B is represented by the following general formula (2).

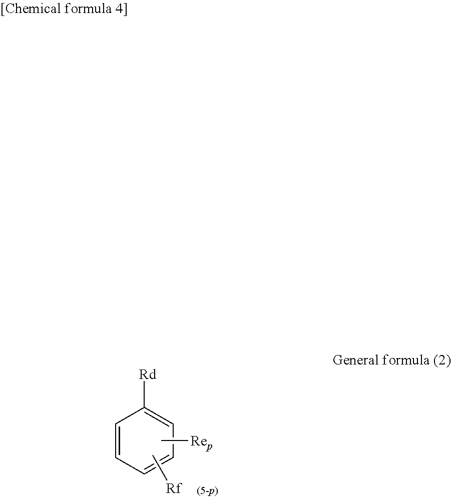

In formula (2), p is an integer of 1 to 5; Rd is a carboxyl group; Re is an aldehyde group, a carboxyl group, an amino group, a hydroxyl group, or a sulfonic acid group, Rf is hydrogen or an optional substituent, and Rd and Re may each independently be bonded to a benzene ring via at least one divalent group selected from the group consisting of —O— and —CH₂—. Examples of the divalent group include —CH₂—CH₂—O—, —CH₂—CH₂—CH₂—O—, and (—CH₂—CH₂—O—) q (q is an integer of 2 or more).

It is considered that compound B is adsorbed on the surface of the precipitated silver and inhibits the growth of silver crystals, thereby decreasing a crystallite size of silver in the composite coating formed by electroplating. This results in a composite material with excellent hardness and therefore excellent wear resistance.

In the above general formula (2), when p is 2 or more, multiple Re's may be the same or different, and when p is 3 or less, multiple Rf's may be the same or different, and regarding Rf's, examples of the “optional substituent” include an alkyl group having 1 to 10 carbon atoms, an alkylaryl group, an acetyl group, a nitro group, a halogen group, and an alkoxyl group having 1 to 10 carbon atoms.

The concentration of compound B in the silver plating solution is preferably 2 to 250 g/L, and more preferably 3 to 200 g/L, from the viewpoint of suppressing unevenness in the appearance of the composite coating and appropriately controlling the crystallite size of silver in the composite coating that is being formed.

### {Complexing Agent}

The silver plating solution used in the present invention preferably contains a complexing agent. The complexing agent complexes the silver ions in the silver plating solution, thereby enhancing the stability of the ions. This action increases the solubility of silver in a solvent that constitutes the plating solution.

A wide variety of complexing agents having the above-described functions can be used, but from the viewpoint of the stability of the formed complex, a compound having a sulfonic acid group is preferable. Examples of the compounds having a sulfonic acid group include alkylsulfonic acids having 1 to 12 carbon atoms, alkanolsulfonic acids having 1 to 12 carbon atoms and hydroxyarylsulfonic acids. Specific examples of these compounds include methanesulfonic acid, 2-propanolsulfonic acid, and phenolsulfonic acid.

The amount of the complexing agent in the silver plating solution is preferably 30 to 200 g/L, and more preferably 50 to 120 g/L, from the viewpoint of stabilizing silver ions.

### {Other Additives}

As other additives, for example, the silver plating solution used in the present invention may contain brighteners, hardeners, and conductive salts. Examples of the hardeners include carbon sulfide compounds (such as carbon disulfide), inorganic sulfur compounds (such as sodium thiosulfate), organic compounds (sulfonates), selenium compounds, tellurium compounds, and metals from group 4B or 5B of the periodic table. The conductive salt may be potassium hydroxide, etc.

### {Solvent}

The solvent constituting the silver plating solution is mainly water. Water is preferable because it has excellent solubility for (complexed) silver ions and other components contained in the plating solution, and it places little strain on the environment. Further, a mixed solvent of water and alcohol may be used as the solvent.

### {Cyanide Compound}

The main components of the silver plating solution used in the present invention are as described above, and the silver plating solution typically does not substantially contain a cyanide compound (specifically, the content of cyanide compound in the silver plating solution is 1 mg/L or less). The cyanide compound is a compound that contains a cyano group (—CN), and the amount of the cyanide compound can be quantified in accordance with JIS K0102:2019. The cyanide compound is subject to the Water Pollution Control Law (effluent standards) and the PRTR (Pollutant Release and Transfer Register) system, and therefore incur a large wastewater treatment cost. As described above, the silver plating solution used in the present invention typically contains substantially no cyanide compounds, and therefore incur a small wastewater treatment cost.

### <Electroplating Conditions>

Next, various conditions for electroplating using the above-described silver plating solution will be described. For example, by electroplating as described below, metal silver is precipitated on the base material, and the surface-treated carbon particles become entrapped in the silver matrix, thereby forming a composite coating. As a result of precipitation and growth of silver at the portion of compound A in the surface-treated carbon particles exposed from the silver matrix that is being formed, it is considered that a predetermined amount of protrusions are formed. Further, when the silver plating solution contains compound B, due to the function of compound B, the crystallite size of silver in the composite coating is suppressed to be small.

### (Cathode and Anode)

The base material to be electroplated is a cathode, and for example a silver electrode plate that dissolves to provide silver ions, is an anode.

### (Current Density)

The cathode and the anode are immersed in the silver plating solution (plating bath), and a current is passed through them to perform silver plating. A current density here is preferably 0.5 to 10 A/dm², more preferably, 1 to 8 A/dm², and even more preferably, 1 to 5 A/dm², from the viewpoint of the formation rate of the composite coating and the viewpoint of suppressing unevenness in the appearance of the composite coating.

### (Temperature, Stirring, Plating Time, Plating Target Area)

The temperature of the plating bath (silver plating solution) during electroplating (plating temperature) is preferably 15 to 50° C., more preferably 20 to 45° C., from the viewpoint of plating production efficiency and preventing excessive evaporation of the solution. In this case, the stirring speed of the plating bath by a stirrer or stirring blade is preferably 200 to 550 rpm, and more preferably 350 to 500 rpm, from the viewpoint of performing uniform plating. The silver plating time (time for applying electric current) can be appropriately adjusted depending on a target thickness of the composite coating, but is typically in the range of 25 to 1800 seconds. An area to be plated may be an entire surface layer of the base material or a part of the surface layer of the base material, depending on the application of the composite material to be produced.

<<Treatment for Partially Removing Carbon Particles from the Composite Coating Surface>>

By the electroplating described above, the composite coating is formed on the base material. In the surface of this composite coating, there are carbon particles that are entrapped and embedded in the silver matrix and are difficult to shed, and carbon particles that are adhered to the surface rather than being entrapped in the silver matrix and are therefore more likely to shed. The latter can contaminate equipment, for example during bending of the composite material. Therefore, it is preferable to remove such carbon particles by rinsing. One rinsing method is to subject the composite coating surface to ultrasonic cleaning. The ultrasonic cleaning is preferably performed at 20 to 100 kHz for 1 to 300 seconds. Another cleaning method is electrolytic cleaning. In this case, the electrolytic cleaning is preferably performed at 1 to 30 A/dm² for 10 to 300 seconds.

### [Composite Material]

Hereinafter, an embodiment of the composite material of the present invention will be described. The composite material is a composite material in which a composite coating composed of a silver layer containing carbon particles is formed on a base material, and when the composite coating surface is observed with a laser microscope, the proportion of predetermined protrusions in an observation field is 12% or more by area. This composite material can be produced, for example, by the method for producing a composite material of the present invention. Each configuration of this composite material will be described below.

### <<Base Material>>

The base material is similar to those described above for the method of producing a composite material of the present invention. That is, Cu (copper) and a Cu alloy are suitable as the constituent materials of the base material, and the Cu alloy is preferably an alloy made of Cu and at least one selected from the group consisting of Si (silicon), Fe (iron), Mg (magnesium), P (phosphorus), Ni (nickel), Sn (tin), Co (cobalt), Zn (zinc), Be (beryllium), Pb (lead), Te (tellurium), Ag (silver), Zr (zirconium), Cr (chromium), Al (aluminum) and Ti (titanium) and inevitable impurities, from the viewpoint of electrical conductivity and strength.

### <<Composite Coating>>

The composite coating formed on the base material is composed of a silver layer containing carbon particles. In this silver layer, carbon particles are dispersed (preferably substantially uniformly) in a matrix composed of silver. When Ag strike plating is performed before forming the composite coating, an intermediate layer resulting from this strike plating layer exists between the base material (or the underlayer described below) and the composite coating, but in many cases it is so thin that it cannot be distinguished from the composite coating. The composite coating may be formed on an entire surface, or on only a portion of the surface of the base material.

### <Carbon Particles>

The carbon particles are the same as the surface-treated carbon particles described above for the method for producing a composite material of the present invention. That is, the carbon particles are preferably graphite particles, and the shape thereof is not particularly limited and may be substantially spherical, flaky, or amorphous, but a flaky shape is preferable because the wear resistance of the composite material can be improved by making the composite coating surface smooth. When the composite material of the present invention is described in the method for producing a composite of the present invention, it is considered that compound A is adsorbed on the surface of the carbon particles.

From the viewpoint of the wear resistance of the composite material, an average primary particle size of the carbon particles is preferably 0.5 to 15 μm, and more preferably 1 to 10 μm. The average primary particle size is an average value of a long diameter of the particles, and the long diameter is defined as a length of a longest line that can be drawn within a particle in an image (flat surface) of a carbon particle in the composite coating of the composite material observed at an appropriate observation magnification. The long diameter is obtained for 50 or more particles.

### <Predetermined Protrusion and Arithmetic Mean Roughness Ra>

The composite coating in the embodiment of the composite material of the present invention has a predetermined protrusion, which exhibits excellent reliability. In this specification, the protrusion is defined as follows.

The composite coating of the composite material is observed with a laser microscope at a magnification of 1000 times, and a height of each pixel (pixel height) in the obtained image in an observation field (143 μm×107.2 μm, composed of 1024×768 pixels) is obtained. This pixel height is calculated as a height difference with respect to a lowest pixel in the observation field (height X of an arbitrary pixel-height Y of a lowest pixel). Then, a pixel height of the pixel whose cumulative number ratio is 10% (10th percentile value) in an arrangement of the pixel heights of the obtained pixels in an ascending order is set as a reference height H₀. A total number of pixels in the observation field is 786432, and a pixel height of the pixel whose cumulative number ratio exceeds 10% for the first time is defined as the reference height H₀ (10th percentile value). The reference height H₀ is, for example, 0.1 to 10 μm, and preferably 0.3 to 5 μm.

A portion (pixel) in the observation field where the pixel height is 1 μm or more higher than H₀ is defined as a protrusion. The composite coating can be formed by a technique such as electroplating, and the above 10th percentile value can be approximated to the height of the portion of the composite coating (plated film) where a flat film is formed, that is, the height of the flat portion. In the present invention, the protrusion is defined as a portion that is higher than the flat portion by a predetermined height (1 μm or more).

As explained in the section “Problem to be solved by the invention”, when the composite material is heated, copper diffuses from the material toward the composite coating, where it reaches the surface of the coating and is oxidized, increasing the resistance of the composite material. On the other hand, in the present invention, although the mechanism is unclear, it is considered that copper is less likely to diffuse into the protrusions that constitute the composite coating. As described above, the protrusion has a height of 1 μm or more being a certain level or more from the reference height H₀.

According to an embodiment of the composite material of the present invention, when the composite coating is observed with the above-described laser microscope, it is considered that copper is less likely to diffuse within the observation field as described above, and excellent reliability is achieved by having tall protrusions being 12% or more by area. The area percentage (protrusion area percentage) can be obtained as the ratio of the number of pixels having a pixel height 1 μm or more higher than H₀ among all pixels constituting the observation field with respect to the total number of pixels. From the viewpoint of the reliability of the composite material and since it is difficult to make the proportion of the protrusions very large in terms of production, the area percentage of the protrusions is preferably 15 to 75% by area, and further, when taking into consideration the electrical conductivity, the proportion is particularly preferably 18 to 70%.

There is no particular upper limit to the height of the protrusion, but the pixel height of the highest pixel among the pixels constituting the observation field (height X_{T} of the highest pixel-height Y of the lowest pixel) is, for example, 1.8 to 25 μm, and preferably 2.4 to 20 μm.

Further, the arithmetic mean roughness Ra of the composite coating surface of the composite material of the present invention having such protrusions is a certain degree of value or more, specifically, for example, 0.6 μm or more (usually 7.0 μm or less).

### <Crystallite Size and Vickers Hardness>

The crystallite size of silver in the composite coating according to an embodiment of the composite material of the present invention is preferably small, less than 40 nm. Such a small crystallite size results in a high hardness of the composite coating due to the Hall-Petch relationship (generally, the smaller the crystal grains of a metal material, the higher its strength is), and the high hardness makes the composite coating less susceptible to abrasion, thereby increasing the wear resistance of the composite material. From the viewpoint of increasing hardness and improving wear resistance, and since it is difficult to make the crystallite size extremely fine in terms of production, the crystallite size is preferably from 2 to 35 nm, more preferably from 2 to 30 nm.

In the present invention, the crystallite size of silver is obtained by averaging (adding up and dividing by 2) the crystallite sizes of the silver (111) and (222) planes in order to reduce bias due to the crystal plane. A more detailed method for measuring the crystallite size will be described in the Examples.

As described above, the composite coating of the preferable embodiment has a small crystallite size and therefore has a high hardness, and specifically, the Vickers hardness Hv is preferably 100 or more, and more preferably 120 to 230. The method for measuring the Vickers hardness Hv will be described in detail in the Examples.

### <Carbon Content and Area Percentage>

The composite coating in the embodiment of the composite material of the present invention contains carbon particles as described above, and from the viewpoint of the wear resistance and electrical conductivity of the composite material, the carbon content in the composite coating is preferably 1 to 50% by mass, more preferably 1.5 to 40% by mass, and even more preferably 2 to 35% by mass.

Further, the ratio (area percentage) of the carbon particles in the surface of the composite coating containing carbon particles is an index of wear resistance, and is preferably 10 to 80% by area, and more preferably 12 to 50% by area from the viewpoint of a balance between wear resistance and electrical conductivity. As explained in the description of the method for producing a composite material of the present invention, carbon particles that are merely attached and easily shed are present on the composite coating surface in some cases. In this case, the area percentage of carbon in the composite coating surface is obtained after the same ultrasonic cleaning treatment as explained in the section <<Treatment for partially removing carbon particles from the composite coating surface>>. The method for measuring the area percentage will be described in detail in the Examples.

### <Total Content of Silver and Carbon>

Regarding elemental composition, the composite coating in an embodiment of the composite material of the present invention typically consists essentially of silver and carbon.

### <Thickness of the Composite Coating>

The thickness of the composite coating is not particularly limited, but it is preferable that the thickness be equal to or more than a minimum value in terms of the wear resistance, reliability, and electrical conductivity. Further, if the thickness is too large, the effect of the composite coating becomes saturated and a raw material cost increases. From the above viewpoints, the thickness of the composite coating is preferably 0.5 to 45 μm, more preferably from 1 to 35 μm, and even more preferably from 1.5 to 25 μm. The composite material of the present invention has a predetermined amount of protrusions in the composite coating, and therefore exhibits excellent reliability even when the composite coating is thin. The thickness of the composite coating is measured by a fluorescent X-ray film thickness meter, and the details of a measurement method will be described in the Examples.

### <<Underlayer>>

An underlayer may be formed between the base material and the composite coating for various purposes. The constituent metal of the underlayer is at least one metal or an alloy selected from the group consisting of Cu, Ni, Sn, and Ag. For example, in order to prevent the copper in the base material from diffusing through to the composite coating surface and deteriorating the electrical conductivity, it is preferable to form the underlayer composed of Ni. When the base material is a copper alloy containing zinc, such as brass, it is preferable to form an underlayer composed of Cu in order to prevent the zinc in the base material from diffusing through to the composite coating surface. For the purpose of improving adhesion of the composite coating to the base material, it is preferable to form an underlayer composed of Ag. Although the thickness of the underlayer is not particularly limited, the thickness is preferably 0.1 to 2 μm, and more preferably 0.2 to 1.5 μm from the viewpoints of functionality and cost. Further, the terminals of electrical and electronic components are often made of materials that have been subjected to Sn plating or reflow Sn plating including Cu undercoat or Ni undercoat (layered structure of Cu undercoat, Ni undercoat, and Sn undercoat from the base material side), and in the present invention, an underlayer having such a layered structure may also be formed. Accordingly, in the present invention, the base of the composite coating may include a layer composed of Cu, Ni, Sn, or Ag, or a layer of a combination of these (a layered structure). Also, different layers may be formed depending on a location, such as forming a composite coating as defined in the present invention on an electrical contact part of the base material (the underlayer may or may not be formed) and forming a reflow Sn plating underlayer on an electric wire crimping part (the composite coating is not formed).

### <<Reliability of the Composite Material>>

The composite material according to the embodiment of the present invention has a composite coating having a predetermined number of the above-described protrusions, and is therefore highly reliable. It also has excellent electrical conductivity equivalent to that of the prior art.

Specifically, the contact resistance measured by a method (four-terminal method) described in the Examples below is preferably 0.6 to 3.0 mΩ at a load of 0.5 N, 0.4 to 2.5 mΩ at a load of 1.0 N, and 0.3 to 2.0 mΩ at a load of 2.0 N, more preferably, 0.6 to 2.8 mΩ at a load of 0.5 N, 0.4 to 2.3 mΩ at a load of 1.0 N, and 0.3 to 1.8 mΩ at a load of 2.0 N.

The contact resistance of the composite material measured by the method (four-terminal method) described in the Examples below after storing the composite material in the air atmosphere at 200° C. for 120 hours is preferably 0.6 to 3.0 mΩ at a load of 0.5 N, 0.5 to 2.5 mΩ at a load of 1.0N, 0.4 to 2.0 mΩ at a load of 2.0N, and more preferably 0.6 to 2.8 mΩ at a load of 0.5N, 0.5 to 2.3 mΩ at a load of 1.0N, and 0.4 to 1.8 mΩ at a load of 2.0N.

Further, from the viewpoint of reliability, the contact resistance before and after storing the composite material in the air at 200° C. for 120 hours (contact resistance after storage under heating/contact resistance before storage under heating) is preferably 0.6 to 2.0, more preferably 0.7 to 1.5, and even more preferably 0.75 to 1.4 at any of 0.5 N, 1.0 N, and 2.0 N

As described above, the composite material according to the embodiment of the present invention shows almost no change in contact resistance before and after heating, and is therefore highly reliable. Further, even with a low load of 1.0N, it shows a sufficiently low resistance. Therefore, for example, although a mating component such as a terminal of a connector (the terminal can be manufactured by bending the composite material of the present invention) is designed to be added with a predetermined stress (stress larger than the above 1.0 N, etc.), even if the stress applied to the terminal decreases to about 1.0 N due to a phenomenon of stress relaxation after long-term use, sufficient conductivity can be ensured.

From the viewpoint of electrical conductivity in addition to reliability, it is preferable that the protrusion area percentage is 30% or more by area and the thickness of the composite coating is 2.8 μm or more, and it is more preferable that the protrusion area percentage is 35 to 62% by area and the thickness of the composite coating is 3.0 μm or more.

### [Terminal]

The composite material according to the embodiment of the present invention is highly reliable, and the composite material of the preferable embodiment has excellent hardness (and therefore excellent wear resistance), and therefore is suitable as a constituent material for terminals for electrical contacts, particularly terminals in electrical contact parts that undergo sliding during use, such as switches and connectors.

### EXAMPLES

Examples of a composite material and a method for producing the same according to the present invention will be described in detail hereafter.

### Example 1

### <Preparation of Carbon Particles: Oxidation Treatment>

80 g of flaky-shaped graphite particles (PAG-3000 manufactured by Nippon Graphite Industries Co., Ltd.) having an average particle size of 4.8 μm as carbon particles were added to 1.4 L of pure water, and the mixture was heated to 50° C. while stirring. The average particle size is a particle size whose cumulative value on a volume basis is 50%, measured using a laser diffraction/scattering type particle size distribution measuring device (MT3300 (LOW-WET MT3000II Mode)) manufactured by MicrotracBEL Corporation. Next, 0.6 L of a 0.1 mol/L aqueous solution of potassium peroxodisulfate as an oxidizing agent was gradually added dropwise to the mixture, and the mixture was then stirred for 2 hours to perform an oxidation treatment, followed by filtering through a filter paper, and a solid matter thus obtained was rinsed with water.

The carbon particles before and after the oxidation treatment were analyzed for the gas generated when heated to 300° C., using a purge and trap gas chromatograph mass spectrometer (a thermal desorption device that is a JHS-100 manufactured by Japan Analytical Industry Co., Ltd., and a gas chromatograph mass spectrometer that is a GCMS QP-5050A manufactured by Shimadzu Corporation). Then, it was found that due to the above oxidation treatment, lipophilic aliphatic hydrocarbons (such as nonane, decane, and 3-methyl-2-heptene) and lipophilic aromatic hydrocarbons (such as xylene) that were adhered to the carbon particles, were removed.

### <Preparation of Carbon Particles: Surface Treatment>

After adding 50 g of the carbon particles after the above oxidation treatment to 1 L of pure water, and 1 g of 2,4-dihydroxybenzoic acid (compound A) was added, and the mixture was stirred at 400 rpm with a stirrer for 1 hour at a liquid temperature of 25° C., thereby performing a surface treatment to the carbon particles, followed by filtering through a filter paper, and the solid matter (carbon particles) thus obtained was rinsed with water.

### <Ag Strike Plating>

A plate material was prepared, which was composed of a Cu—Ni—Sn—P alloy (a copper alloy plate material containing 1.0 mass % Ni, 0.9 mass % Sn, 0.05 mass % P, with a remainder being Cu and unavoidable impurities) (NB-109EH manufactured by Dowa Metaltech Co., Ltd.) measuring 5.0 cm in length, 5.0 cm in width, and 0.2 mm in thickness. With this plate material used as a base material, and using this base material as a cathode and an iridium oxide mesh electrode plate (a titanium mesh material coated with iridium oxide) used as an anode, electroplating (silver strike plating) was performed at a liquid temperature of 25° C. and a current density of 5 A/dm2 for 60 seconds, in a sulfonic acid-based silver strike plating solution (Dain Silver GPE-ST manufactured by Daiwa Kasei Co., Ltd., substantially free of cyanide compounds, silver concentration of 3 g/L, methanesulfonic acid concentration of 42 g/L) containing methanesulfonic acid as a complexing agent. Silver strike plating was applied to an entire surface of the base material.

### <AgC Plating>

The carbon particles (graphite particles) that have been subjected to the above-described oxidation treatment and surface treatment were added to a sulfonic acid-based silver plating solution (Dain Silver GPE-HB manufactured by Daiwa Kasei Co., Ltd. (containing compound B corresponding to general formula (2) at a concentration of 4.2 g/L, and a solvent is mainly water)) containing methanesulfonic acid as a complexing agent and having a silver concentration of 30 g/L and a methanesulfonic acid concentration of 60 g/L, to prepare a carbon particle-containing sulfonic acid-based silver plating solution containing surface-treated carbon particles at a concentration of 50 g/L, silver at a concentration of 30 g/L, and methanesulfonic acid at a concentration of 60 g/L. This silver plating solution is substantially free of Sb and cyanide compounds.

Next, with a silver strike plated base material used as a cathode and a silver electrode plate used as an anode, electroplating was performed in the carbon particle-containing sulfonic acid-based silver plating solution at a temperature of 25° C. and a current density of 3 A/dm² for 180 seconds while stirring with a stirrer at 400 rpm, to obtain a composite material in which a composite coating (AgC plating coating) containing carbon particles in a silver layer was provided on the base material. The composite coating was formed on an entire surface of the base material.

### <Ultrasonic Cleaning Treatment>

The composite coating surface of the obtained composite material was subjected to ultrasonic cleaning treatment at 28 kHz for 4 minutes using an ultrasonic cleaner (VS-100III manufactured by AS ONE Corporation, output 100 W, tank interior dimensions: length 140 mm×width 240 mm×depth 100 mm), with water as a liquid medium.

The manufacturing conditions, etc., of the above composite materials are summarized in Tables 1 and 2 below, along with the production conditions of Examples 2 to 7 and Comparative Examples 1 to 5 described below.

The obtained composite material was evaluated as follows.

### <Crystallite Size of Silver in the Composite Coating>

X-ray diffraction measurement (Cu Kα X-ray tube, tube voltage: 30 kV, tube current: 10 mA, step width: 0.02°, scanning range: 2θ=10° to 154°, scanning speed: 10°/min, measurement time: about 15 minutes, (111) plane peak: 2θ=37.9 to 38.7°, (222) plane peak: 2θ=79 to) 82.2° were performed to the surface of the above composite coating, using an X-ray diffraction apparatus (RINT-2000 manufactured by Rigaku Corporation) in accordance with JIS H7805:2005. From the detected peaks of the silver (111) and (222) planes, a full width at half maximum (FWHM) was obtained using X-ray analysis software (PDXL manufactured by Rigaku Corporation), and the crystallite size in each silver crystal plane was calculated using Scherrer's formula. In order to reduce bias due to a crystal plane, an average value of crystallite sizes of silver of the (111) and (222) planes was taken as a crystallite size of silver. The crystallite size was 26.3 nm.

The Scherrer formula is as follows:

D=Kλ/(β cos θ)

D: crystallite size
K: Scherrer constant, set to 0.9
λ: X-ray wavelength, 1.54 Å for CuKα radiation
β: full width at half maximum (FWHM) (rad)
θ: measurement angle (deg)

### <Carbon Area Percentage in the Composite Coating Surface>

The composite coating surface was observed using a tabletop microscope (TM4000 Plus manufactured by Hitachi High-Tech Corporation) at an accelerating voltage of 5 kV and a magnification of 1000 times, and a backscattered electron composition (COMPO) image (one field of view) was binarized using GIMP 2.10.10 (image analysis software), and the area percentage of carbon in the composite coating surface was calculated. Specifically, when a highest brightness of all pixels is 255 and a lowest brightness is 0, a gradation was binarized in such a way that pixels with a brightness of 127 or less are black and pixels with a brightness of more than 127 are white. Then, the image was separated into a silver portion (white portion) and a carbon particle portion (black portion), and the ratio Y/X of the number of pixels Y in the carbon particle portion with respect to the number of pixels X in an entire image was calculated as the carbon area percentage (%) on the surface.

### <Vickers Hardness Hv of the Composite Coating Surface>

The Vickers hardness Hv of the composite coating surface was measured in accordance with JIS Z 2244 using a microhardness tester (HM221 manufactured by Mitsutoyo Corporation) by applying a load of 0.01 N to a flat portion of the composite material for 15 seconds, and an average value of three measurements was used. As a result, the Vickers hardness Hv was 174.

### <Thickness of the Composite Coating>

The thickness of this composite coating (a circular area with a diameter of 0.2 mm at a center portion in a surface of 5.0 cm in length and 5.0 cm in width) was measured with a fluorescent X-ray thickness meter (FT9450 manufactured by Hitachi High-Tech Science Corporation) and the result shows that the thickness was 3.3 μm. It is difficult to detect C atoms (of carbon particles) with a fluorescent X-ray thickness meter, so the thickness is obtained by detecting Ag atoms. In the present invention, the thickness obtained in this manner is regarded as the thickness of the composite coating.

### <Arithmetic Mean Roughness of the Composite Coating>

An image of the composite coating surface was taken at a magnification of 1000 times using a laser microscope (VKX-110 manufactured by Keyence Corporation), and the arithmetic mean roughness Ra, a parameter that represents surface roughness (over an entire observed composite coating surface), was calculated using an analysis application (VK-HIXA version 3.8.0.0 manufactured by Keyence Corporation) based on JIS B 0601 (2001), and the result was 2.6 μm.

### <Reference Height H₀ and Maximum Height>

“Surface inclination correction (automatic)” using an analysis application (VK-HIXA version 3.8.0.0 manufactured by Keyence Corporation) was performed to an image including height data of each pixel constituting an observation field (143 μm×107.2 μm, composed of 1024×768 pixels) obtained by observing with the laser microscope in order to obtain the arithmetic average roughness Ra, and with this application, a frequency distribution chart was created for the height of each pixel (pixel height) constituting the image in the observation field. The pixel height of each pixel was calculated as a height (height difference) relative to a lowest pixel that is set to 0 in the observation field, and a 10th percentile value in the frequency distribution chart was calculated using the statistical software Rstudio (Version 1.4.1103, free software). This is the reference height H₀ in the present invention, and specifically, it was 1.6 μm. Further, the height (maximum height) of the tallest pixel was 17.1 μm.

### <Area Percentage of the Protrusions>

In the image of the observation field from which the reference height H₀ was obtained, the ratio of the number of pixels whose pixel height is (H₀+1) μm or more with respect to the total number of pixels constituting the observation field, that is, the area percentage of the protrusions, was obtained. The result shows that the area percentage of the protrusions was 67.8% by area.

### <Reliability Evaluation>

### (Initial Resistance Value)

A base material measuring 2.0 cm wide and 3.0 cm long was cut out from the same Cu—Ni—Sn—P alloy plate material as used in Example 1, and Ag strike plating and AgC plating were performed under the same conditions as in Example 1 to obtain a composite material (flat test piece).

The same Cu—Ni—Sn—P alloy plate material as used in Example 1 was cut into a size of 4.0 cm in length and 1.0 cm in width, and an indentation (extrusion into a hemispherical shape) with an inner diameter of 1.0 mm was applied to the center. The indented protrusion-side surface (the surface pressed against the flat test piece below) was subjected to plating (AgSb plating) in the same manner as in Comparative Example 4 described later to obtain an indentation test piece.

This flat test piece was placed in a sliding wear tester (CRS-G2050-DWA, manufactured by Yamazaki Seiki Laboratory Co., Ltd.), and the contact resistance when the protrusion of the indented test piece was pressed against it with constant loads (0.5, 1.0, and 2.0N) was measured using a four-terminal method. The results were 1.5 mΩ at 0.5 N, 1.3 mΩ at 1.0 N, and 1.0 mΩ at 2.0 N.

(Evaluation of a Resistance Value after Storage Under Heat)

The flat test piece was stored in the air at 200° C. for 120 hours (the test piece attached with indent was not stored under heat). Thereafter, the contact resistance was measured by the four-terminal method in the same manner as described above, and the result was 1.8 mΩ at 0.5 N, 1.2 mΩ at 1.0 N, and 0.9 mΩ at 2.0 N.

The above evaluation results are summarized in Tables 3 and 4 below, together with the evaluation results of Examples 2 to 7 and Comparative Examples 1 to 5, which will be described later.

### Example 2

A composite material was prepared in the same manner as in Example 1, except that the plating time for AgC plating was 120 seconds.

The thickness, Vickers hardness Hv, protrusion area percentage, maximum height, arithmetic mean roughness Ra, carbon area percentage in the composite coating surface, and reliability of the obtained composite material were evaluated in the same manner as in Example 1. The reference height H₀ was 2.9 μm.

### Example 3

A composite material was prepared in the same manner as in Example 1, except that the plating time for AgC plating was 300 seconds.

The obtained composite material was evaluated in the same manner as in Example 1 for the thickness of the composite coating, Vickers hardness Hv, protrusion area percentage, maximum height, arithmetic mean roughness Ra, carbon area percentage in the composite coating surface, and reliability. The reference height H₀ was 2.5 μm.

### Example 4

A composite material was prepared in the same manner as in Example 1, except that the plating time for AgC plating was 600 seconds.

The obtained composite material was evaluated in the same manner as in Example 1 for the thickness of the composite coating, Vickers hardness Hv, protrusion area percentage, maximum height, arithmetic mean roughness Ra, carbon area percentage in the composite coating surface, and reliability. The reference height H₀ was 0.3 μm.

### Example 5

A composite material was prepared in the same manner as in Example 1, except that the plating time for AgC plating was 1200 seconds.

The obtained composite material was evaluated in the same manner as in Example 1 for the thickness of the composite coating, Vickers hardness Hv, protrusion area percentage, maximum height, arithmetic mean roughness Ra, carbon area percentage in the composite coating surface, and reliability. The reference height H₀ was 1.3 μm.

### Example 6

A composite material was prepared in the same manner as in Example 1, except that the time for surface treatment for the carbon particles was 180 hours.

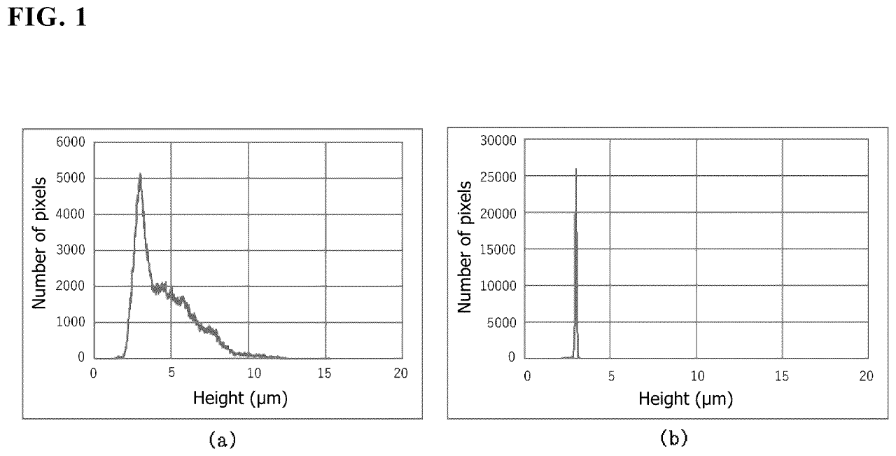

The obtained composite material was evaluated in the same manner as in Example 1 for the thickness of the composite coating, Vickers hardness Hv, protrusion area percentage, maximum height, arithmetic mean roughness Ra, carbon area percentage in the composite coating surface, and reliability. The reference height H₀ was 2.6 μm. FIG. 1(a) shows a frequency distribution chart prepared for obtaining the protrusion area percentage, in which the horizontal axis represents the pixel height of each pixel, and the vertical axis represents the frequency (number) of each pixel constituting the image observed with a laser microscope.

### Example 7

With the same base material as in Example 1 used as a cathode and a Ni electrode plate used as an anode, electroplating (Ni plating) was performed in a nickel plating bath (aqueous solution) consisting of nickel sulfamate at a concentration of 342 g/L (Ni concentration of 80 g/L) and boric acid at a concentration of 45 g/L, at a liquid temperature of 55° C. and a current density of 4 A/dm² for 40 seconds while stirring, to form 0.3 μm thick Ni coating (Ni underlayer) on the base material. The thickness of the underlayer was measured in the same manner as that for obtaining the thickness of the composite coating.

A composite material was produced in the same manner as in Example 1, except that Ag strike plating was applied to a base material having a Ni undercoat.

The obtained composite material was evaluated in the same manner as in Example 1 for the thickness of the composite coating, Vickers hardness Hv, protrusion area percentage, maximum height, arithmetic mean roughness Ra, carbon area percentage in the composite coating surface, and reliability. The reference height H₀ was 3.1 μm.

### Comparative Example 1

A silver-plated material having a silver plating film formed on a base material was produced in the same manner as in Example 1, except that Ag plating was performed using a sulfonic acid-based silver plating solution (Dain Silver GPE-HB (containing a compound corresponding to general formula (2) and mainly using water as a solvent) manufactured by Daiwa Kasei Co., Ltd.) containing Ag at a concentration of 30 g/L and containing methanesulfonic acid at a concentration of 60 g/L as a complexing agent instead of the carbon particle-containing sulfonic acid-based silver plating solution.

The obtained composite material was evaluated in the same manner as in Example 1 for the thickness of the silver plating film, Vickers hardness Hv, protrusion area percentage, maximum height, arithmetic mean roughness Ra, carbon area percentage in the composite film surface, and the reliability. The reference height H₀ was 2.5 μm.

### Comparative Example 2

A composite material was produced in the same manner as in Example 1, except that the carbon particles were not surface-treated. The time from preparation of the sulfonic acid-based silver plating solution containing carbon particles to the start of electroplating was about 10 minutes.

The obtained composite material was evaluated in the same manner as in Example 1 for the thickness of the composite coating, Vickers hardness Hv, protrusion area percentage, maximum height, arithmetic mean roughness Ra, carbon area percentage in the composite coating surface, and reliability. The reference height H₀ was 2.4 μm.

### Comparative Example 3

For the composite material produced in Example 3, three drops of abrasive (DP Lubricant Red, manufactured by Struers Corporation, model number 40700070, emulsion-based (containing diamond abrasive grains with a particle size of 3 μm or less)) were placed on a polishing cloth (MD-Mol manufactured by Struers Corporation, model number 40500220, 100% taffeta wool) set on a benchtop sample polisher (LaboPol 20 manufactured by Struers Corporation), and the composite coating was pressed against the polishing cloth for five seconds while rotating the polishing cloth at 100 rpm, thereby performing buff polishing. After polishing, the arithmetic mean roughness of the composite coating was calculated using a laser microscope in the same manner as in Example 1. Further, the thickness of the composite coating was measured in the same manner as in Example 1. The thickness was decreased by 0.2 μm. This operation was repeated, and the polishing was terminated when the surface roughness Ra became 1.0 μm or less for the first time.

The obtained (polished) composite material was evaluated in the same manner as in Example 1 for the thickness of the composite coating, Vickers hardness Hv, protrusion area percentage, arithmetic mean roughness Ra, carbon area percentage in the composite coating surface, and reliability. The reference height H₀ was 2.9 μm. FIG. 1(b) shows a frequency distribution chart prepared for determining the protrusion area percentage, in which the horizontal axis represents the pixel height of each pixel, and the vertical axis represents the frequency (number) of each pixel constituting the image observed with a laser microscope.

### Comparative Example 4

### <Ag Strike Plating>

A base material similar to that in Example 1 was prepared, and with this base material used as a cathode and a titanium platinum mesh electrode plate (titanium mesh material plated with platinum) used as an anode, electroplating (Ag strike plating) was performed in a cyan-based Ag strike plating solution (bath made from general reagents, silver cyanide concentration 3 g/L, potassium cyanide concentration 90 g/L, solvent is water) containing a cyanide compound as a complexing agent, at 25° C. with a current density of 5 A/dm² for 30 seconds.

### <AgSb Plating>

A cyan-based Ag—Sb alloy plating solution (solvent: water) containing a cyanide compound as a complexing agent and having a silver concentration of 60 g/L and an antimony (Sb) concentration of 2.5 g/L was prepared. The cyan-based Ag—Sb alloy plating solution contains 10% by mass of silver cyanide, 30% by mass of sodium cyanide, and Nissin Bright N (manufactured by Nissin Kasei Co., Ltd.), and the concentration of Nissin Bright N in the plating solution was 50 mL/L. Nissin Bright N contains a brightener and diantimony trioxide, and the concentration of diantimony trioxide in Nissin Bright N is 6% by mass.

Next, with the above Ag strike plated material used as a cathode and the silver electrode plate used as an anode, electroplating was performed in the above cyan-based Ag—Sb alloy plating solution for 300 seconds at a temperature of 18° C. and a current density of 3 A/dm², while stirring with a stirrer at 400 rpm, to obtain a composite material in which a composite coating (silver-antimony coating) was formed on a base material.

The obtained composite material was evaluated in the same manner as in Example 1 for the thickness of the composite coating, Vickers hardness Hv, protrusion area percentage, maximum height, arithmetic mean roughness Ra, carbon area percentage in the composite coating surface, and reliability. The reference height H₀ was 2.2 μm.

### Comparative Example 5

A composite material in which a composite coating was provided on a base material was produced in the same manner as in Example 1, except that a sulfonic acid-based silver plating solution (Dain Silver GPE-PL (not containing the compound represented by general formula (2) and using water as the solvent) manufactured by Daiwa Kasei Co., Ltd.) containing methanesulfonic acid at a concentration of 60 g/L as a complexing agent and having a silver concentration of 30 g/L was used instead of the sulfonic acid-based silver plating solution of Example 1, and carbon particles (graphite particles) that had been subjected to an oxidation treatment in the same manner as in Example 1 were added thereto, and the resulting carbon particle-containing sulfonic acid-based silver plating solution was used to perform AgC plating with a plating time of 300 seconds.

The obtained composite material was evaluated in the same manner as in Example 1 for the thickness of the composite coating, Vickers hardness Hv, protrusion area percentage, maximum height, arithmetic mean roughness Ra, carbon area percentage of the composite coating surface, and silver crystallite size of the composite coating. The reference height H₀ was 3.2 μm. Reliability evaluation was not performed in this comparative example 5.

The production conditions, etc., for the above-described Examples 1 to 7 and Comparative Examples 1 to 5 are summarized in Tables 1 and 2, and various evaluation results are summarized in Tables 3 and 4.

TABLE 1

| | | | | Example | | Example | | Example | | Example | |
|---|---|---|---|---|---|---|---|---|---|---|---|
| | | | | 1 | | 2 | | 3 | | 4 | |
| Underlayer | Main components | Nickel | | — | | — | | — | | — | |
| | of plating solution | Complexing agent (boric acid) | | | | | | | | | |
| | Current density | | | | | | | | | | |
| | Plating temperature | | | | | | | | | | |
| | Plating time | | | | | | | | | | |
| Strike | Main components | Silver ion | | 3 | g/L | 3 | g/L | 3 | g/L | 3 | g/L |
| plating | of plating solution | Complexing | Methasulfonic acid | 42 | g/L | 42 | g/L | 42 | g/L | 42 | g/L |

| | | | | | |
|---|---|---|---|---|---|
| agent | Others | — | — | — | — |

| | Current density | | 5 | A/dm² | 5 | A/dm² | 5 | A/dm² | 5 | A/dm² |
|---|---|---|---|---|---|---|---|---|---|---|
| | Plating temperature | | 25° | C. | 25° | C. | 25° | C. | 25° | C. |
| | Plating time | | 60 | sec | 60 | sec | 60 | sec | 60 | sec |
| C pre- | Oxidation treatment | | With | | With | | With | | With | |
| treatment | | | treatment | | treatment | | treatment | | treatment | |
| | Treatment with | With or without treatment | With | | With | | With | | With | |
| | compound A | | treatment | | treatment | | treatment | | treatment | |
| | | Treatment time | One hour | | One hour | | One hour | | One hour | |
| Ag-based | Main components | Silver ion | 30 | g/L | 30 | g/L | 30 | g/L | 30 | g/L |

| | | | | | | |
|---|---|---|---|---|---|---|
| plating | of plating solution | Compound B | Present | Present | Present | Present |

| | | | | | | | | | |
|---|---|---|---|---|---|---|---|---|---|
| Complexing | Methasulfonic acid | 60 | g/L | 60 | g/L | 60 | g/L | 60 | g/L |

| | | | | | |
|---|---|---|---|---|---|
| agent | Others | — | — | — | — |

| | | | | | | | | |
|---|---|---|---|---|---|---|---|---|
| Concentration of surface- | 50 | g/L | 50 | g/L | 50 | g/L | 50 | g/L |

treated carbon particles

| | | | | | | | | |
|---|---|---|---|---|---|---|---|---|
| Current density | 3 | A/dm² | 3 | A/dm² | 3 | A/dm² | 3 | A/dm² |
| Plating temperature | 25° | C. | 25° | C. | 25° | C. | 25° | C. |
| Plating time | 180 | sec | 120 | sec | 300 | sec | 600 | sec |

| | | | | Example | | Example | | Example | |
|---|---|---|---|---|---|---|---|---|---|
| | | | | 5 | | 6 | | 7 | |
| Underlayer | Main components | Nickel | | — | | — | | 80 | g/L |
| | of plating solution | Complexing agent (boric acid) | | | | | | 45 | g/L |
| | Current density | | | | | | | 4 | A/dm² |
| | Plating temperature | | | | | | | 55° | C. |
| | Plating time | | | | | | | 40 | sec |
| Strike | Main components | Silver ion | | 3 | g/L | 3 | g/L | 3 | g/L |
| plating | of plating solution | Complexing | Methasulfonic acid | 42 | g/L | 42 | g/L | 42 | g/L |

| | | | | |
|---|---|---|---|---|
| agent | Others | — | — | — |

| | Current density | | 5 | A/dm² | 5 | A/dm² | 5 | A/dm² |
|---|---|---|---|---|---|---|---|---|
| | Plating temperature | | 25° | C. | 25° | C. | 25° | C. |
| | Plating time | | 60 | sec | 60 | sec | 60 | sec |
| C pre- | Oxidation treatment | | With | | With | | With | |
| treatment | | | treatment | | treatment | | treatment | |
| | Treatment with | With or without treatment | With | | With | | With | |
| | compound A | | treatment | | treatment | | treatment | |
| | | Treatment time | One hour | | 180 | hours | One hour | |
| Ag-based | Main components | Silver ion | 30 | g/L | 30 | g/L | 30 | g/L |

| | | | | | |
|---|---|---|---|---|---|
| plating | of plating solution | Compound B | Present | Present | Present |

| | | | | | | | |
|---|---|---|---|---|---|---|---|
| Complexing | Methasulfonic acid | 60 | g/L | 60 | g/L | 60 | g/L |

| | | | | |
|---|---|---|---|---|
| agent | Others | — | — | — |

| | | | | | | |
|---|---|---|---|---|---|---|
| Concentration of surface- | 50 | g/L | 50 | g/L | 50 | g/L |

treated carbon particles

| | | | | | | |
|---|---|---|---|---|---|---|
| Current density | 3 | A/dm² | 3 | A/dm² | 3 | A/dm² |
| Plating temperature | 25° | C. | 25° | C. | 25° | C. |
| Plating time | 1200 | sec | 180 | sec | 180 | sec |

TABLE 2

| | | | | Comparative | | Comparative | | Comparative | | Comparative | Comparative | |
|---|---|---|---|---|---|---|---|---|---|---|---|---|
| | | | | example 1 | | example 2 | | example 3 | | example 4 | example 5 | |
| Underlayer | Main components | Nickel | | — | | — | | — | | — | — | |
| | of plating solution | Complexing agent | | | | | | | | | | |
| | | (boric acid) | | | | | | | | | | |
| | Current density | | | | | | | | | | | |
| | Plating temperature | | | | | | | | | | | |
| | Plating time | | | | | | | | | | | |
| Strike | Main components | Silver ion | | 3 | g/L | 3 | g/L | 3 | g/L | AgCN(3 g/L) | 3 | g/L |
| plating | of plating solution | Complexing | Methasulfonic | 42 | g/L | 42 | g/L | 42 | g/L | — | 42 | g/L |
| | | agent | acid | | | | | | | | | |

| | | | | | |
|---|---|---|---|---|---|
| Others | — | — | — | KCN(90 g/L) | — |

| | | | | | | | | | | |
|---|---|---|---|---|---|---|---|---|---|---|
| Current density | 5 | A/dm² | 5 | A/dm² | 5 | A/dm² | 5 | A/dm² | 5 | A/dm² |
| Plating temperature | 25° | C. | 25° | C. | 25° | C. | 25° | C. | 25° | C. |
| Plating time | 60 | sec | 60 | sec | 60 | sec | 30 | sec | 60 | sec |

| C pre- | Oxidation treatment | | — | | With | | With | | Without | With | |
|---|---|---|---|---|---|---|---|---|---|---|---|
| treatment | | | | | treatment | | treatment | | treatment | treatment | |
| | Treatment with | With or without treatment | — | | Without | | With | | Without | Without | |
| | compound A | | | | treatment | | treatment | | treatment | treatment | |
| | | Treatment time | — | | — | | One hour | | — | — | |
| Ag-based | Main components | Silver ion | 30 | g/L | 30 | g/L | 30 | g/L | AgCN (Ag | 30 | g/L |

| | | | | | | | |
|---|---|---|---|---|---|---|---|
| plating | of plating solution | | | | | concentration: | |
| | | | | | | 60 g/L) | |
| | | Compound B | Present | Present | Present | Absent | Absent |

| | | | | | | | | | | |
|---|---|---|---|---|---|---|---|---|---|---|
| Complexing | Methasulfonic | 60 | g/L | 60 | g/L | 60 | g/L | — | 60 | g/L |
| agent | acid | | | | | | | | | |

| | | | | | |
|---|---|---|---|---|---|
| Others | — | — | — | NaCN | — |

| Other Additives | — | | — | | — | | *1 (Sb | | — | |
|---|---|---|---|---|---|---|---|---|---|---|
| | | | | | | | concentration: | | | |
| | | | | | | | 2.5 g/L) | | | |
| Concentration of | 0 | g/L | 50 | g/L | 50 | g/L | 0 | g/L | 50 | g/L |
| carbon particles | | | | | | | | | | |

| | | | | | | | | | | |
|---|---|---|---|---|---|---|---|---|---|---|
| Current density | 3 | A/dm² | 3 | A/dm² | 3 | A/dm² | 3 | A/dm² | 3 | A/dm² |
| Plating temperature | 25° | C. | 25° | C. | 25° | C. | 18° | C. | 25° | C. |
| Plating time | 180 | sec | 180 | sec | 300 | sec | 300 | sec | 300 | sec |

| | | | | | |
|---|---|---|---|---|---|
| Polishing | Not | Not | Polished | Not | Not |
| | polished | polished | | polished | polished |

*1 Nissin Bright N (brightener) 50 mL/L, the concentration of diantimony trioxide in Nissin Bright N is 6% by mass

TABLE 3

| | | | Example | | Example | | Example | | Example | | Example | | Example | | Example | |
|---|---|---|---|---|---|---|---|---|---|---|---|---|---|---|---|---|
| | | | 1 | | 2 | | 3 | | 4 | | 5 | | 6 | | 7 | |
| Underlayer (Ni) | | | None | | None | | None | | None | | None | | None | | 0.3 | μm |
| Coating | Composition | | AgC | | AgC | | AgC | | AgC | | AgC | | AgC | | AgC | |
| | Thickness | | 3.3 | μm | 2.1 | μm | 5.7 | μm | 10.0 | μm | 17.9 | μm | 3.6 | μm | 3.5 | μm |
| | Vickers hardness Hv | | 174 | | 168 | | 175 | | 186 | | 140 | | 171 | | 180 | |
| | Protrusion area percentage | | 67.8% | | 19.2% | | 44.1% | | 21.3% | | 49.2% | | 58.3% | | 44.5% | |
| | Maximum height | | 17.1 | μm | 15.3 | μm | 10.5 | μm | 2.5 | μm | 3.9 | μm | 15.3 | μm | 10.7 | μm |
| | Arithmetic mean roughness Ra | | 2.6 | μm | 0.7 | μm | 3.4 | μm | 4.4 | μm | 5.5 | μm | 1.6 | μm | 1.4 | μm |
| | Surface carbon area percentage | | 26.2% | | 14.9% | | 19.1% | | 27.3% | | 33.8% | | 18.7% | | 20.1% | |
| | Crystallite size | | 26.3 | nm | — | | — | | — | | — | | — | | — | |
| Resistance | Load 0.5N | Before storage | 1.5 | mΩ | 2.2 | mΩ | 1.5 | mΩ | 0.7 | mΩ | 0.9 | mΩ | 0.8 | mΩ | 0.8 | mΩ |
| value | | under heating | | | | | | | | | | | | | | |
| (reliability) | | After storage | 1.8 | mΩ | 1.9 | mΩ | 1.4 | mΩ | 1.4 | mΩ | 1.1 | mΩ | 1.0 | mΩ | 1.0 | mΩ |
| | | under heating | | | | | | | | | | | | | | |
| | Load 1N | Before storage | 1.3 | mΩ | 1.6 | mΩ | 1.1 | mΩ | 0.5 | mΩ | 0.6 | mΩ | 0.7 | mΩ | 0.7 | mΩ |
| | | under heating | | | | | | | | | | | | | | |
| | | After storage | 1.2 | mΩ | 1.4 | mΩ | 1.1 | mΩ | 0.8 | mΩ | 0.7 | mΩ | 0.7 | mΩ | 0.7 | mΩ |
| | | under heating | | | | | | | | | | | | | | |
| | Load 2N | Before storage | 1.0 | mΩ | 1.3 | mΩ | 0.9 | mΩ | 0.4 | mΩ | 0.4 | mΩ | 0.5 | mΩ | 0.6 | mΩ |
| | | under heating | | | | | | | | | | | | | | |
| | | After storage | 0.9 | mΩ | 1.0 | mΩ | 0.8 | mΩ | 0.7 | mΩ | 0.5 | mΩ | 0.6 | mΩ | 0.7 | mΩ |
| | | under heating | | | | | | | | | | | | | | |

TABLE 4

| | | Comparative | | Comparative | | Comparative | | Comparative | | Comparative | |
|---|---|---|---|---|---|---|---|---|---|---|---|
| | | example 1 | | example 2 | | example 3 | | example 4 | | example 5 | |
| Underlayer (Ni) | | None | | None | | None | | None | | None | |
| Coating | Composition | Ag | | AgC | | AgC | | AgSb | | AgC | |
| | Thickness | 3.6 | μm | 3.4 | μm | 5.4 μm | | 5.8 | μm | 6.6 | μm |
| | | | | | | (After polishing) | | | | | |
| | Vickers hardnessHv | 172 | | 170 | | 176 | | 180 | | 70 | |
| | Protrusion area percentage | 0.0% | | 9.3% | | 0.0% | | 0.0% | | 5.7% | |
| | Maximum height | 3.3 | μm | 9.1 | μm | 3.3 | μm | 3.0 | μm | 6.7 | μm |
| | Arithmetic mean roughness Ra | 0.2 | μm | 0.5 | μm | 0.1 | μm | 0.1 | μm | 0.3 | μm |

| Surface carbon area percentage | 0% | 17.8% | 13.1% | 0% | 60% | |
|---|---|---|---|---|---|---|
| Crystallite size | — | — | — | — | 71.7 | nm |

| | | | | | | | | | | | |
|---|---|---|---|---|---|---|---|---|---|---|---|
| Resistance | Load 0.5N | Before storage | 2.0 | mΩ | 1.2 | mΩ | 2.0 | mΩ | 3.2 | mΩ | — |
| value | | under heating | | | | | | | | | |
| (reliability) | | After storage | 21.7 | mΩ | 3.3 | mΩ | 30.7 | mΩ | 21.2 | mΩ | |
| | | under heating | | | | | | | | | |
| | Load 1N | Before storage | 1.2 | mΩ | 0.8 | mΩ | 1.6 | mΩ | 2.0 | mΩ | |
| | | under heating | | | | | | | | | |
| | | After storage | 6.8 | mΩ | 1.8 | mΩ | 7.2 | mΩ | 11.4 | mΩ | |
| | | under heating | | | | | | | | | |
| | Load 2N | Before storage | 0.9 | mΩ | 0.6 | mΩ | 1.1 | mΩ | 1.4 | mΩ | |
| | | under heating | | | | | | | | | |
| | | After storage | 4.5 | mΩ | 1.1 | mΩ | 2.5 | mΩ | 4.3 | mΩ | |
| | | under heating | | | | | | | | | |

From Comparative Example 2, it is found that when the carbon particles are not treated with compound A (surface treatment), the protrusions are not sufficiently formed, resulting in poor reliability. From Comparative Example 3, it is found that even in the case of the composite coating that has been subjected to the above-described surface treatment, the reliability deteriorates when the protrusions are removed.

1. A composite material in which a composite coating composed of a silver layer containing carbon particles is provided on a base material,
wherein when observing the composite coating with a laser microscope to obtain a pixel height, which is a height difference between each pixel constituting an observation field and a lowest pixel in the observation field, and when a pixel height of a pixel whose cumulative number ratio is 10% in an arrangement of pixel heights in an ascending order is defined as a reference height H₀, and a pixel in the observation field whose pixel height is 1 μm or more higher than the reference height H₀ is defined as a protrusion, a proportion of the protrusions in the observation field is 12% or more by area.

2. The composite material according to claim 1, wherein the base material is composed of Cu or a Cu alloy.

3. The composite material according to claim 1, wherein a crystallite size of silver in the composite coating is 40 nm or less.

4. The composite material according to claim 1, wherein a proportion of the protrusions is 15 to 75% by area.

5. The composite material according to claim 1, wherein a proportion of the carbon particles in a composite coating surface is 10 to 80% by area.

6. The composite material according to claim 1, wherein a thickness of the composite coating is 1.5 to 25 μm.

7. The composite material according to claim 1, wherein the composite coating surface has a Vickers hardness of 100 or more.

8. The composite material according to claim 1, wherein the composite coating has an arithmetic mean roughness Ra of 0.6 μm or more.

9. The composite material according to claim 1, wherein an underlayer composed of at least one selected from a group consisting of Cu, Ni, Sn, and Ag is provided between the base material and the composite coating.

10. A method for producing a composite material, comprising:
performing electroplating in a silver plating solution containing carbon particles; and
forming a composite coating composed of a silver layer containing carbon particles on a base material,
wherein the carbon particles are surface-treated carbon particles that have been treated in an aqueous solution, with compound A represented by the following general formula (1) for 30 minutes or more, 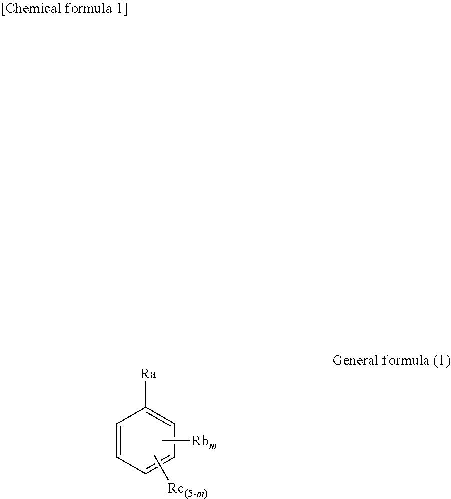
(in formula (1), m is an integer from 1 to 5;
Ra is a carboxyl group;
Rb is an aldehyde group, a carboxyl group, an amino group, a hydroxyl group, or a sulfonic acid group;
Rc is hydrogen or an arbitrary substituent;
when m is 2 or more, multiple Rb's may be the same or different;
when m is 3 or less, multiple Rc's may be the same or different; and
Ra and Rb may each independently be bonded to a benzene ring via a divalent group composed of at least one selected from a group consisting of —O— and —CH₂—.)

11. The method for producing a composite material according to claim 10, wherein the silver plating solution contains the surface-treated carbon particles and a compound B represented by the following general formula (2): 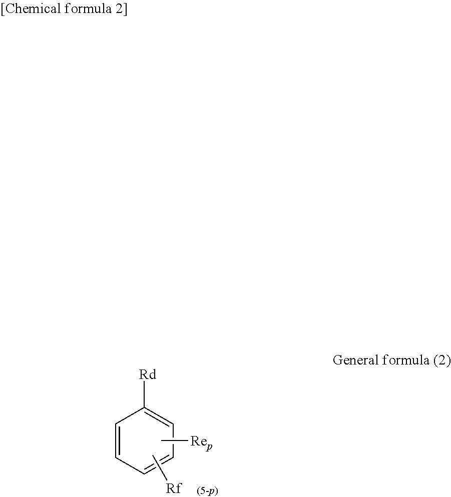
(in formula (2), p is an integer from 1 to 5,
Rd is a carboxyl group,
Re is an aldehyde group, a carboxyl group, an amino group, a hydroxyl group, or a sulfonic acid group,
Rf is hydrogen or an arbitrary substituent,
when p is 2 or more, multiple Re's may be the same or different,
when p is 3 or less, multiple Rf's may be the same or different, and
Rd and Re may each independently be bonded to a benzene ring via a divalent group composed of at least one selected from a group consisting of —O— and —CH₂—.)

12. The method for producing a composite material according to claim 10, wherein the base material is composed of Cu or a Cu alloy.

13. The method for producing a composite material according to claim 10, wherein the treatment for the carbon particles with compound A is performed by stirring an aqueous solution containing the carbon particles and compound A for 30 minutes or more.

14. The method for producing a composite material according to claim 10, wherein a concentration of compound B in the silver plating solution is 2 to 250 g/L.

15. The method for producing a composite material according to claim 10, wherein the silver plating solution contains silver ions at a concentration of 5 to 150 g/L.

16. The method for producing a composite material according to claim 10, wherein a concentration of the surface-treated carbon particles in the silver plating solution is 10 to 150 g/L.

17. A terminal for electrical contacts, the terminal comprising the composite material according to claim 1 as a constituent material.
